(19) United States
(12) Patent Application Publication
(10) Pub. No.: US 2015/0193832 A1
(43) Pub. Date: Jul. 9, 2015

(54) METHOD, APPARATUS, AND SYSTEM FOR COMMUNICATING AND PRESENTING PRODUCT INFORMATION

(71) Applicant: Alibaba Group Holding Limited, George Town (KY)

(72) Inventors: Zhiqiang Zhu, Hangzhou (CN); Chen Peng, Hangzhou (CN)

(21) Appl. No.: 14/589,501

(22) Filed: Jan. 5, 2015

(30) Foreign Application Priority Data
Jan. 6, 2014 (CN) 201410004927.2

(51) Int. Cl. G06Q 30/02

(52) U.S. Cl. CPC G06Q 30/0276; G06Q 30/0277

(57) ABSTRACT

Embodiments of the present application relate to a method, apparatus, and system for presenting information. The method includes determining, by a receiver terminal, identifying information corresponding to presentation-related information, searching for an image corresponding to the identifying information among one or more images stored on the receiver terminal, in response to the receiver terminal finding the image corresponding to the identifying information, presenting the image corresponding to the identifying information, in response to determining that the receiver is not able to locate the image corresponding to the identifying information among the one or more images stored on the receiver terminal, invoking a rendering template to populate the presentation-related information into the rendering template, and rendering the populated template to generate rendered information, generating, based on the rendered information, a presentation result comprising a generated image, and establishing a correspondence between the identifying information and the generated image.

### CROSS REFERENCE TO OTHER APPLICATIONS

This application claims priority to People's Republic of China Patent Application No. 201410004927.2 entitled A METHOD AND A DEVICE FOR PRESENTING INFORMATION, filed Jan. 6, 2014 which is incorporated herein by reference for all purposes.

### FIELD OF THE INVENTION

The present application relates to a method, apparatus, and system for communicating and presenting product information.

### BACKGROUND OF THE INVENTION

Instant messaging clients (hereinafter abbreviated as “clients”) have become an important channel for promoting products in e-commerce. For example, a user may share product information with other users through a client. Through clients, a user sends or otherwise shares the product information that the user is currently browsing to another user.

According to some related art, a subset of the information included in the product information is predefined according to a specified characteristic in order to facilitate sharing of product information with other users. The subset of information includes shop names, product names, product prices, amount of product remaining in stock, and/or the like. When a user shares product information via a client, the client automatically acquires a subset of information included in the product information according to the specified characteristics from within the product information. Thereafter, the client sends the subset of information included in the product information to other users. According to some related art, the client automatically acquires and sends the subset of information included in the product information without requiring the user to manually enter the specific information that the user wishes to share with another user via the client.

Furthermore, in consideration of the aesthetics and readability of the information shared with other users, a client according to some related art can add the acquired subset of information of the product information to a preset template and render and present the subset of information according to the preset template to other users.

However, according to practical applications of the sharing of product information with other users via clients, avoiding a situation according to which a plurality of different sender users share the same product information with the same receiver user is impossible. For example, the receiver client is required to invoke the saved template each time the receiver client receives the same product information and add the received product information to the template for rendering. As a result, the receiver client is required to render the same product information multiple times (e.g., for each instance in which the receiver user receives the product information one of the plurality of different sender users), thereby wasting both the computing resources associated with the rendering process and the power capacity of the device on which the client is located.

The above information is presented as background information only to assist with an understanding of the present disclosure. No determination has been made, and no assertion is made, as to whether any of the above might be applicable as prior art with regard to the present disclosure.

### BRIEF DESCRIPTION OF THE DRAWINGS

Various embodiments of the invention are disclosed in the following detailed description and the accompanying drawings.

The drawings described here are intended to further the understanding of the present application and form a part of this application. The illustrative embodiments of the present application and the descriptions thereof are intended to explain this application and do not constitute inappropriate limitation of the present application. Among the drawings:

FIG. 1 is a flowchart of a method for presenting information according to various embodiments of the present disclosure.

FIG. 2 is a flowchart of a method for presenting information according to various embodiments of the present disclosure.

FIG. 3A is a diagram of a presentation of information using a template according to various embodiments of the present disclosure.

FIG. 3B is a diagram of a presentation of information by directly presenting a URL corresponding to presentation-related information according to various embodiments of the present disclosure.

FIG. 3C is a diagram of a programming framework used to construct a template according to various embodiments of the present disclosure.

FIG. 4 is a diagram of a template preset for presentation of information according to various embodiments of the present application.

FIG. 5 is a flowchart of a method for presenting information according to various embodiments of the present disclosure.

FIG. 6 is a flowchart of a method for presenting information according to various embodiments of the present disclosure.

FIG. 7 is a diagram illustrating a system for presenting information according to various embodiments of the present disclosure.

FIG. 8 is a structural block diagram of an information presentation device provided by an embodiment of the present application.

FIG. 9 is a structural block diagram of a sender device provided by an embodiment of the present application.

FIG. 10 is a functional diagram of a computer system for presenting information, according to various embodiments of the present disclosure.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

According to various embodiments of the present disclosure, a method, an apparatus, and/or a system is provided for communicating and presenting product information. According to various embodiments of the present disclosure, a method, an apparatus, and/or a system is provided for communicating across devices (e.g., clients) and presenting product information to a user. In some embodiments, the product information includes color, shape, one or more specific characteristics, texture, and/or the like.

According to various embodiments of the present disclosure, a device includes communication functionality. For example, a device can be a smart phone, a tablet Personal Computer (PC), a mobile phone, a video phone, an e-book reader, a desktop PC, a laptop PC, a netbook PC, a Personal Digital Assistant (PDA), a Portable Multimedia Player (PMP), an mp3 player, a mobile medical device, a camera, a wearable device (e.g., a Head-Mounted Device (HMD), electronic clothes, electronic braces, an electronic necklace, an electronic accessory, an electronic tattoo, or a smart watch), and/or the like.

According to various embodiments of the present disclosure, a device can be a smart home appliance with communication functionality. A smart home appliance can be, for example, a television, a Digital Video Disk (DVD) player, an audio, a refrigerator, an air conditioner, a vacuum cleaner, an oven, a microwave oven, a washer, a dryer, an air purifier, a set-top box, a TV box (e.g., Samsung HomeSync™, Apple TV™, or Google TV™), a gaming console, an electronic dictionary, an electronic key, a camcorder, an electronic picture frame, and/or the like.

According to various embodiments of the present disclosure, a device may be a medical device (e.g., Magnetic Resonance Angiography (MRA) device, a Magnetic Resonance Imaging (MRI) device, Computed Tomography (CT) device, an imaging device, or an ultrasonic device), a navigation device, a Global Positioning System (GPS) receiver, an Event Data Recorder (EDR), a Flight Data Recorder (FDR), an automotive infotainment device, a naval electronic device (e.g., naval navigation device, gyroscope, or compass), an avionic electronic device, a security device, an industrial or consumer robot, and/or the like.

According to various embodiments of the present disclosure, a device can be furniture, part of a building/structure, an electronic board, electronic signature receiving device, a projector, various measuring devices (e.g., water, electricity, gas or electro-magnetic wave measuring devices), and/or the like that include communication functionality.

According to various embodiments of the present disclosure, a device can be any combination of the foregoing devices. In addition, it will be apparent to one having ordinary skill in the art that a device according to various embodiments of the present disclosure is not limited to the foregoing devices.

According to some related art, when a plurality of different sender clients share the same product information for presenting with a particular receiver client, the receiver client will render and present the received product information multiple times. For example, the receiver client will render the received product information to be presented through a template each time the receiver client receives the product information for presenting. As a result, the receiver client according to some related art wastes computing resources and power used by the rendering process. However, according to various embodiments of the present disclosure, the receiver client saves objects (e.g., images) that present the product information for presenting whenever at least a subset of the product information for presenting is rendered and/or presented. According to various embodiments of the present disclosure, in response to receiving the same product information for presenting, the receiver client directly presents the saved image to the user without having to render the product information for presenting again. Accordingly, the receiver client can effectively conserve the computing resources and power that are used by rendering product information for presenting.

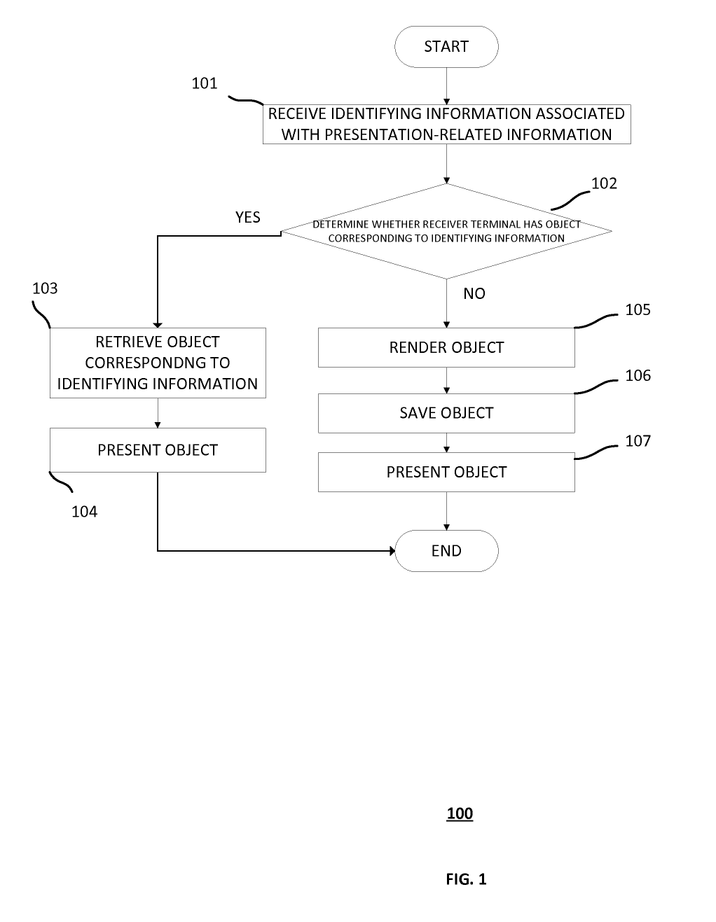

FIG. 1 is a flowchart of a method for presenting information according to various embodiments of the present disclosure.

Referring to FIG. 1, a method 100 for presenting information (e.g., product information) is provided. In some embodiments, the method 100 is implemented by a device such as terminal 710 illustrated in FIG. 7.

At 101, identifying information associated with presentation-related information is received. In some embodiments, a device receives identifying information associated with presentation-related information (e.g., information to be presented). For example, a receiver terminal (e.g., a receiver client) receives the identifying information associated with presentation-related information. In some embodiments, the receiver terminal receives the identifying information associated with the presentation-related information concurrently with presentation-related information. For example, the identifying information can be metadata included with the presentation-related information. In some embodiments, the receiver terminal receives the identifying information associated with the presentation-related information from a sender device (e.g., a sender terminal, a server, and/or the like). In some embodiments, the presentation-related information corresponds to product information.

According to various embodiments of the present disclosure, the receiver terminal uses a preset process to generate corresponding identifying information for the presentation-related information. In some embodiments, the identifying information for the presentation-related information is generated based on certain content or information. For example, the identifying information for the presentation-related information can be generated using the Message Digest Algorithm Version 5 (MD5). In some embodiments of the present disclosure, the identifying information for the presentation-related information is generated using a random number in combination with a time stamp. For example, the receiver terminal receives the presentation-related information and generate the identifying information associated therewith based at least in part on the presentation-related information that was received. In some embodiments, the preset process is set on the basis of need. In some embodiments, an algorithm that provides a unique identifier that is relatively short is used to determine the identifying information for the received to-be-presented information. As an example, the MD5 can be employed to determine the identifying information for the received to-be-presented information. As another example, Cyclic Redundancy Check (CRC) can be employed to determine the identifying information for the received to-be-presented information. As another example, the Secure Hash Algorithm (SHA) can be employed to determine the identifying information for the received to-be-presented information. In some embodiments, MD5 is used to temporarily store a URL in shorter form while guaranteeing that each identifying information is unique (e.g., while guaranteeing that each URL is unique). In some embodiments, the URL is used as the key (e.g., no computation method is used to determine the identifying information for the received to-be-presented information, rather the URL is directly used as such identifying information).

At 102, a determination is made as to whether an object corresponding to the identifying information is stored. In some embodiments, the receiver terminal determines whether the receiver terminal has (e.g., stores in its memory or file system) an object corresponding to the identifying information. For example, the receiver terminal determines whether the receiver terminal stores an object (e.g., a previously rendered object corresponding to the presentation-related information that is associated with the identifying information). In some embodiments, the object is an image.

If an object corresponding to the identifying information is stored, then the object corresponding to the identifying information is retrieved. Thereafter, the object is presented. In some embodiments, if the receiver terminal determines that the receiver terminal has an object corresponding to the identifying information at 102, then the receiver terminal proceeds to 103 at which the receiver terminal retrieves the object corresponding to the identifying information. Thereafter, at 104, the receiver terminal presents (e.g., provides, displays, or the like) the object (e.g., to the user at a display).

In contrast, if an object corresponding to the identifying information is not stored, then an object is rendered. In some embodiments, if the receiver terminal determines that the receiver terminal does not have an object corresponding to the identifying information at 102, then the receiver terminal proceeds to 105 at which the receiver terminal renders an object. For example, the receiver terminal invokes a rendering template for presenting the presentation-related information (e.g., product information), and add at least a subset of the presentation-related information to the rendering template and render at least the subset of the presentation-related information as an object (e.g., as an image).

According to various embodiments of the present disclosure, the rendering template is a template for presenting presentation-related information (e.g., product information). In some embodiments, the template comprises several zones. In some embodiments, the presentation-related information includes product information, vendor information, product names, the like, or any combination thereof. In some embodiments, the specified characteristic information included in the presentation-related information is added to the zones for rendering and presentation. According to various embodiments of the present disclosure, in order to improve the aesthetics and readability of information presented, a predetermined data format is adopted to assemble presentation-related information. For example, a sender terminal sends, to the receiver terminal, the presentation-related information according to a predetermined data format. In some embodiments, the sender terminal sends the assembled presentation-related information to a receiver terminal. For example, the presentation-related information is assembled as data in the JSON (JavaScript Object Notation) format. In response to receiving the presentation-related information in JSON format, the receiver terminal invokes one or more rendering templates (e.g., JavaScript template rendering engines) to render the presentation-related information. Thereafter, the rendered information is presented (e.g., to the user). In some embodiments, the presentation-related information is assembled as data in the Extensible Markup Language (XML) format.

At 106, the object may be saved. For example, the receiver terminal stores the rendered object. In some embodiments, the receiver terminal stores the rendered object according to one or more predefined data formats. According to various embodiments of the present disclosure, the receive terminal generates the presentation result of the presentation-related information as an image and save the presentation result. In some embodiments, the receiver terminal associates identifying information of the presentation-related information with the stored object. For example, the receiver terminal establishes a correspondence between the identifying information of the presentation-related information and the generated object (e.g., generated presentation result, presentation-related information, and/or the like).

At 107, the receiver terminal may present the rendered presentation-related information. For example, the receiver terminal displays the rendered object to the user.

In some embodiments, in response to the presentation-related information being completely rendered and presented, the receiver terminal invokes a drawing utility to draw the presented presentation-related information as an image. For example, the receiver terminal draws the rendered (and presented) object as an image.

If the receiver terminal is an Android system device, then the receiver terminal invokes the drawing application programming interface (API) in the Android system to generate and present an image of the presentation-related information and to save the image when the receiver terminal generates an image of the presentation-related information. According to various embodiments of the present disclosure, a correspondence between the identifying information associated with the presentation-related information and the generated image is established, and the correspondence between the identifying information associated with the presentation-related information and the generated image is saved locally at the receiver terminal.

According to various embodiments of the present disclosure, the objects saved to the receiver terminal (e.g., the generated and presented objects) is deleted according to a predefined deletion policy, according to user preferences, and/or according to user input. For example, the images saved by the receiver terminals is deleted according to a set time interval or deleted manually by users.

According to various embodiments of the present disclosure, if a receiver terminal subsequently receives the same presentation-related information that is sent from one or more other sender terminals, then the receiver terminal uses the preset process to determine identifying information corresponding to the presentation-related information (e.g., identifying information corresponding to the presentation-related information received from the one or more other sender terminals). Thereupon, the receiver terminal searches for (e.g., looks up) an object (e.g., an image) corresponding to the identifying information among objects (e.g., images) saved by the receiver terminal. If the receiver terminal finds an object (e.g., an image) corresponding to the identifying information, then the receiver terminal directly presents the found (e.g., looked up) object (e.g., image) without having to again render the presentation-related information through a template. In some embodiments, the use of a search for stored objects corresponding to the identifying information and the presentation of the found objects corresponding to the identifying information effectively conserves computing resources and power that the receiver terminal would have used to render the presentation-related information.

Although the use of a predetermined data format for assembling presentation-related information that is sent to by the sender terminal to the receiver terminal improves aesthetics and readability of information, the receiver terminal is required to be able to process and/or analyze information in the predetermined data format. For example, the use of assembling presentation-related information with JSON format can improve the aesthetics and readability of shared information. However, the receiver terminal needs to have the capability to analyze JSON-format data. In view of the limitation to the use of a predetermined data format, in practical applications, the capabilities of terminals (e.g., clients or applications installed on the terminals) used by users cannot all be the same (e.g., client applications used by different terminals may be different). When the receiver terminal has a receiver client that is an earlier version of the client application, the receiver terminal might not be able to support the data format (or presentation-related information) used by other terminals that have later-version clients. Thus, after terminal that has an earlier-version client receives the presentation-related information, the terminal might not be able to correctly analyze the presentation-related information.

Therefore, according to various embodiments of the present application, the sender terminal (e.g., the sender client installed thereon) does not assemble the presentation-related information in a specific data format. Rather, the sender terminal sends, to the receiver terminal, a Uniform Resource Locator (URL) for the presentation-related information. If a receiver terminal (e.g., a receiver client installed thereon) has saved the presentation-related information in a template used to present information presenting, then the receiver terminal can use the URL as a basis for acquiring corresponding presentation-related information, invoking the rendering template, and adding the acquired presentation-related information to the rendering template for rendering and presentation. In contrast, if the receiver terminal (e.g., the receiver client) has not saved a rendering template (e.g., if the receiver terminal fails to invoke a rendering template for presenting the presentation-related information), then the receiver client directly presents the URL. Thus, because receiver terminals having a later-version receiver client will save a template for presenting presentation-related information so as to enhance the aesthetics and readability of shared information, but receiver terminals having an earlier-version receiver client will not save a rendering template, the following occurs: if, after the receiver terminal receives a URL corresponding to the presentation-related information that is sent by the sender terminal (e.g., the sender client), the receiver terminal (e.g., the receiver client) is able to invoke a rendering template for presenting the presentation-related information, then the receiver terminal has a later version of a receiver client. However, if the receiver terminal fails to invoke a template, then the receiver terminal has an earlier version of receiver client. If the receiver terminal has a later version of a receiver client, then the receiver terminal (e.g., the receiver client) can acquire presentation-related information according to the received URL and thereafter add the acquired to presentation-related information to a template for rendering and presentation. In some embodiments, if the receiver terminal has an earlier version of a receiver client, then the receiver terminal (e.g., the receiver client) directly presents the received URL. Subsequently, the receiver terminal (e.g., the receiver client) can, on the basis of the URL, acquire the presentation-related information through a browser.

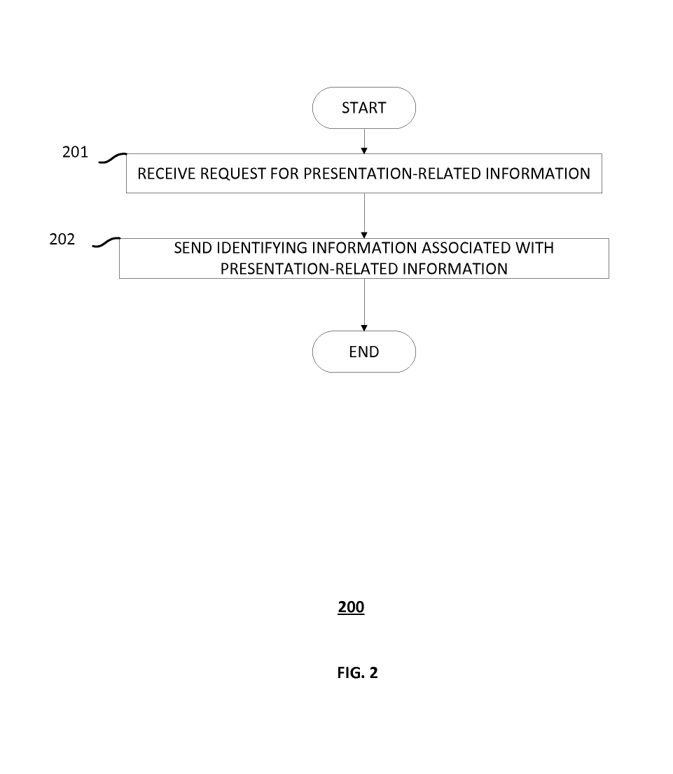

FIG. 2 is a flowchart of a method for presenting information according to various embodiments.

Referring to FIG. 2, a method 200 for presenting information is provided. In some embodiments, the method 200 is implemented by a device such as terminal 720 illustrated in FIG. 7.

At 201, a device receives a request for presentation-related information. For example, a sender device (e.g., a sender terminal) receives a request for presentation-related information (e.g., product information). According to various embodiments of the present disclosure, the sender terminal receives the request for the product information from a receiver terminal.

According to various embodiments of the present application, when browsing product information, a sender terminal invokes a share function for sharing the product information being browsed and/or product information for a specific product. For example, when browsing product information, a sender user clicks on a “Share” button. In response to the clicking of the “Share” button, a sharing feature for sharing the product information being browsed and/or product information relating to a product associated with the click of the “Share” button is invoked. In some embodiments, the sender terminal generates a sharing request for this product information (e.g., in response to the share function being invoked). As an example, the sharing request includes the product information (e.g., the presentation-related information). In some embodiments, the sharing request is formatted according to the intent protocol on Android. In some embodiments, according to the protocol (e.g., the intent protocol on Android), the request is formatted by using (parameter name+parameter value) as the key, placing the key in the intent of a request, and thereafter using an android Application Program Interface (API) to pass the intent to a corresponding app to be processed. In some embodiments, the app translates the data into binary format. In some embodiments, Transmission Control Protocol (TCP) is used to send the data to the server. In some embodiments, the server uses TCP to send the data to the app on the receiving terminal.

At 202, identifying information associated with the presentation-related information is sent. In some embodiments, the sender terminal sends identifying information associated with the presentation-related information. In some embodiments, the sender terminal sends the identifying information associated with the presentation-related information to a receiver device. In some embodiments, the sender terminal sends the identifying information associated with the presentation-related information concurrently with presentation-related information. For example, the identifying information is or otherwise includes metadata included with the presentation-related information. In some embodiments, the sender terminal sends the identifying information associated with the presentation-related information to a receiver device (e.g., a receiver terminal, a server, and/or the like). In some embodiments, the presentation-related information corresponds to or otherwise includes product information.

According to various embodiments of the present disclosure, the identifying information associated with the presentation-related information is generated based at least in part on the presentation-related information. For example, the sender terminal uses a preset process to generate corresponding identifying information for the presentation-related information. In some embodiments, the preset process is set on the basis of need. As an example, the MD5 is used to determine the identifying information for the presentation-related information.

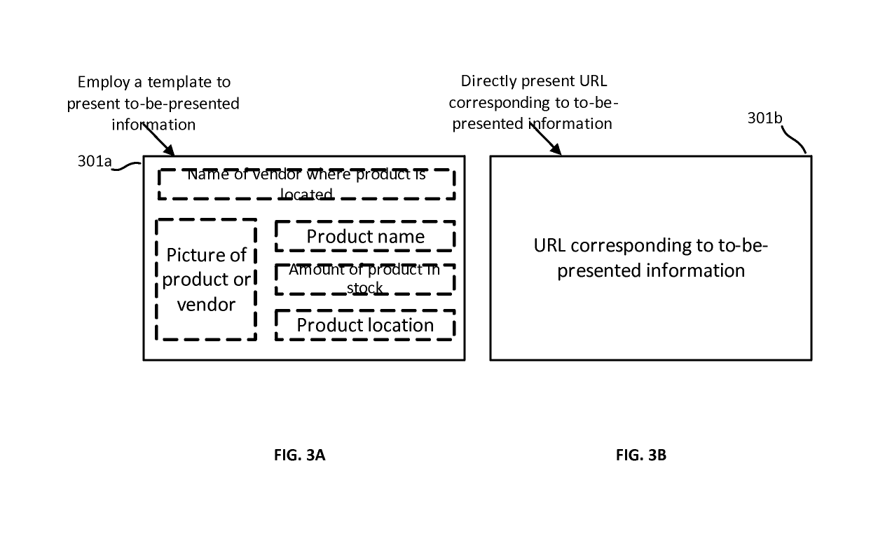

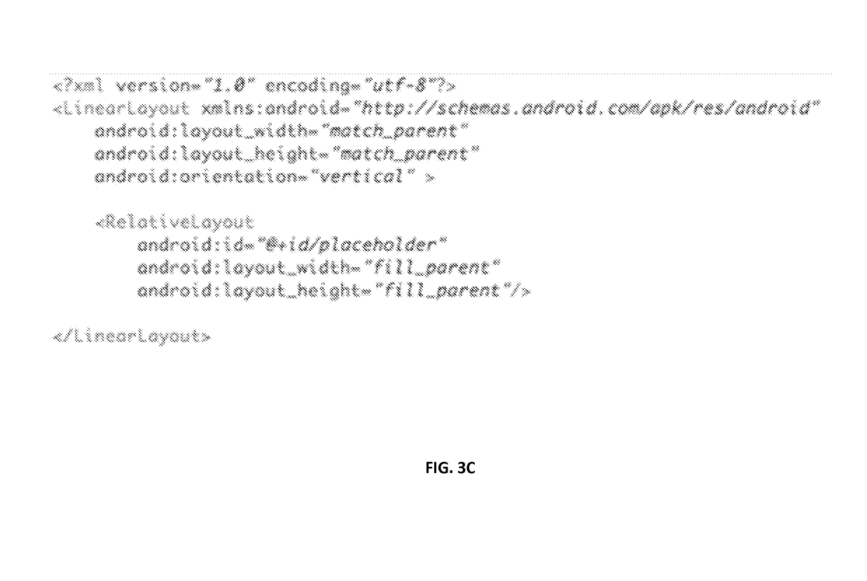

FIG. 3A is a diagram of a presentation of information using a template according to various embodiments of the present disclosure. FIG. 3B is a diagram of a presentation of information by directly presenting a URL corresponding to presentation-related information according to various embodiments of the present disclosure.

Referring to FIG. 3A, a presentation 301a of information using a template is provided. In some embodiments, the presentation 301a is implemented or otherwise presented by a terminal such as terminal 720 illustrated in FIG. 7. Referring to FIG. 3B, a presentation 301b of information using a template is provided. In some embodiments, the presentation 301b is implemented or otherwise presented by a terminal such as terminal 720 illustrated in FIG. 7. Referring to FIG. 3C, a programming framework used to construct a template is provided. In some embodiments, the programming framework is implemented or is used by a terminal such as terminal 720 illustrated in FIG. 7.

As illustrated in FIG. 3A, if the presentation-related information is product information, then the presentation-related information that is presented with a template includes one or more of a name of the vendor at which the product is located (e.g., the name of the vendor offering the product for sale), an image of one or more of the product and the vendor, a name of the product, an amount of product remaining in stock (e.g., at the vendor), a location of the product, and other such information. As can be seen from the presentation 301a of product information using the template as shown in FIG. 3A, the product information presented through the template is easier to perceive visually and more aesthetically pleasing, As a result, the presentation 301a of the product information helps the user understand the product information. As illustrated in FIG. 3B, if the receiver terminal does not support a data format associated with the product information (e.g., if the receiver terminal has an earlier version of a receiver client), then the URL that is sent by the sender terminal (e.g., the sender client) is directly presented to the user. According to various embodiments of the present disclosure, a browser is invoked by selection of the URL (e.g., a user operatively invokes the browser by clicking on the URL). The browser uses the URL to acquire the presentation-related information (e.g., the product information) corresponding to the URL from the server. In some embodiments, the programming framework illustrated in FIG. 3C is used to construct the template (e.g., the template illustrated in FIG. 3A). As an example, the app uses an android template. In some embodiments, the template is defined using XML.

According to various embodiments of the present disclosure, the receiver terminal presents (e.g., displays) historical information relating to the presentation-related information. For example, the receiver terminal (e.g., a receiver client installed thereon) presents historical information relating to the presentation-related information when the receiver terminal repeatedly receives the same presentation-related information (e.g., when the receiver terminal receives the same presentation-related information from a plurality of different sender terminals). According to various embodiments of the present disclosure, the receiver terminal (e.g., the receiver client installed thereon) uses the same approach for displaying historical information relating to the presentation-related information in response to receiving the presentation-related information from a plurality of different sender terminals as the receiver terminal uses to present presentation-related information in response to receiving presentation-related information from a plurality of different sender terminals. For example, a receiver terminal having a later-version client is not required to re-acquire presentation-related information corresponding to a previously received URL and render the presentation-related information (e.g., through a template) if the receiver terminal has previously presented (e.g., previously rendered) the presentation-related information. Rather, the receiver terminal (e.g., the later-version receiver client) determines the identifying information corresponding to the URL that was previously received, searches for an object corresponding to the identifying information (e.g., looks up an image corresponding to the identifying information) among locally saved objects (e.g., images) and presents a located object corresponding to the identifying information.

According to various embodiments of the present disclosure, presentation-related information includes many types of information. For example, the presentation-related information includes information on the type of vendor, information on the type of product, a category of the product, the like, or a combination thereof.

According to various embodiments of the present disclosure, in order to further enhance the aesthetics and readability of the presentation-related information, the presentation-related information is presented according to one of a plurality of preset presentation templates. For example, the receiver terminal stores various different preset presentation templates for presenting presentation-related information. In some embodiments, the various different preset presentation templates relates to different categories. The various different preset presentation templates is stored on receiver clients (on later-version clients specifically) of the receiver terminal. Thus, after a receiver terminal (e.g., a receiver client of the receiver terminal) receives a URL sent by a sender terminal (e.g., a sender client), the receiver terminal (e.g., the receiver client) invokes a template to be used to present the presentation-related information. When the receiver terminal (e.g., the receiver client) invokes a template used to present the presentation-related information, the receiver terminal (e.g., the receiver client) uses the category information of the presentation-related information that is carried in the received URL to invoke a template corresponding to the category information. If the receiver terminal (e.g., receiver client) fails to invoke a template corresponding to the category information included in the received URL, then the receiver terminal (e.g., the receiver client) can directly present the URL.

For example, assuming that the URL received by the receiver client is http://item.example.com/item.htm?id=1234567, the “item” in the URL corresponds to the category information of the presentation-related information. The category information (e.g., the “item” in the URL) indicates that the presentation-related information is product-type information. Accordingly, the receiver terminal (e.g., the receiver client) can invoke a template corresponding to product-type information. In another example, assuming that the URL received by the receiver client is http://shop106482759.example.com/?, the “shop” in the URL corresponds to the category information for the presentation-related information. In some embodiments, the Ser. No. 10/648,2759 refers to a unique identifier corresponding to the vendor (e.g., shop). In some embodiments, each vendor (e.g., shop) is associated with a unique URL. The category information (e.g., the “shop” in the URL) indicates that the presentation-related information is shop-type information. Accordingly, the receiver terminal (e.g., the receiver client) can invoke a template corresponding to shop-type information.

According to various embodiments of the present application, when the receiver terminal (e.g., the receiver client) acquires presentation-related information according to the received URL, the receiver terminal (e.g., the receiver client) can establish a connection with the server according to the URL and acquire from the server information corresponding to the URL that serves as acquired presentation-related information. According to various embodiments of the present disclosure, the presentation-related information might include all the information on a page currently browsed by the receiver terminal (e.g., the user). In order to reduce the network resources used by the acquired presentation-related information, an embodiment of the present disclosure presets some specified characteristics such that, when a sender terminal (e.g., a sender client) sends a URL, the information of the specified characteristics included in the presentation-related information is included in the URL corresponding to the presentation-related information, and the URL is then sent to the receiver terminals (e.g., the receiver clients). In some embodiments, the information of the specified characteristics in the embodiment of the present application corresponds to the information in the presentation-related information that is sent along with the specified characteristics. In some embodiments, the specified characteristics correspond to the information included in the URL. In some embodiments, the specified characteristics refer to various categories of parameters used to display the page such as, for example, a vendor name, an image of the vendor, a product name, the like, or any combination thereof.

The sender terminal (e.g., the sender client) can acquire information of specified characteristics included in the presentation-related information and included the information of the specified characteristics in a URL. Thereafter, the sender terminal (e.g., the sender client installed on the server terminal) sends the URL (e.g., the URL including the information of the specified characteristics) to one or more receiver terminals (e.g., receiver clients installed on receiver terminals). Accordingly, when a receiver terminal (e.g., a receiver client installed on a receiver terminal) acquires presentation-related information according to a received URL, the receiver terminal can use preset specified characteristics as a basis for acquiring information of the specified characteristics included in the URL and using the acquired information of the specified characteristics as the acquired presentation-related information. If the receiver terminal (e.g., the receiver client) fails to acquire information of the specified characteristics from the URL, then the receiver terminal (e.g., the receiver client installed on the receiver terminal) can establish a connection according to the URL with the corresponding server and acquire information corresponding to the URL from the server. Moreover, the receiver terminal can extract information of the specified characteristics from the acquired information and use the extracted information of the specified characteristics as the acquired presentation-related information. Examples of the characteristics include name of the vendor at which the product is located, image of the vendor, name of the product, amount of product in stock, location of the product.

According to various embodiments of the present disclosure, when a template for presenting presentation-related information is configured (e.g., preset), the specified characteristics is preset.

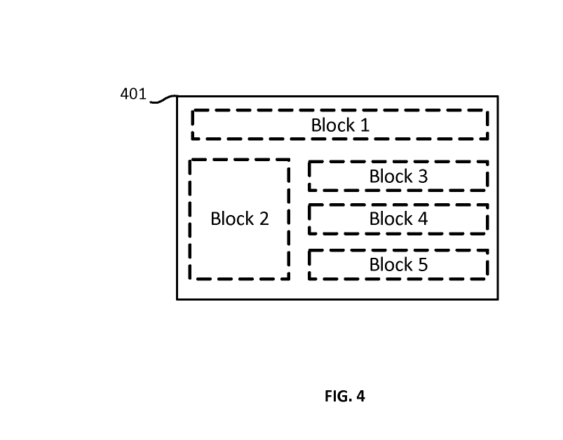

FIG. 4 is a diagram of a template preset for presentation of information according to various embodiments of the present application.

Referring to FIG. 4, a preset template 401 for presenting information is provided. In some embodiments, the preset template is configured or otherwise used by a terminal such as terminal 720 illustrated in FIG. 7.

As illustrated in FIG. 4, the template 401 is partitioned into one or more blocks. The template 401 is partitioned according to the information to be included in the template (e.g., the amount of information, the type of information, and/or the like). For example, the template 401 is partitioned into a total of five blocks numbered 1 through 5. According to various embodiments of the present disclosure, block 1 is preset for adding the name of the vendor at which the product is located; block 2 is preset for adding an image of the vendor or the like; block 3 is preset for adding the name of the product; block 4 is preset for adding the amount of product in stock (e.g., at the quantity of product that the vendor has in stock); and block 5 preset is for adding the location of the product. In some embodiments, the preset specified characteristics corresponds to five characteristics: name of the vendor at which the product is located, image of the vendor, name of the product, amount of product in stock, and location of the product.

Accordingly, when a sender terminal (e.g., a sender user) browses presentation-related information, the presentation-related information browsed by the sender terminal is in fact the information included on a web page (e.g., the URL corresponding to the web page being the URL corresponding to the presentation-related information). For example, the presentation-related information that is accessed by the sender terminal corresponds to all the information included on the web page. However, the information included on the web page can include other information in addition to information of the aforesaid five characteristics (e.g., name of the vendor at which the product is located, image of the vendor, name of the product, amount of product in stock, and location of the product). For example, the information included on the web page also includes other information such as product price, the number of times the product was bookmarked, product evaluations, and ratings of the vendor at which the product is located, the like, or a combination thereof. The sender terminal (e.g., the sender client) can use the aforesaid preset five specified characteristics as a basis for acquiring information of the specified characteristics and the acquired information of the specified characteristics in the URL corresponding to the page.

According to various embodiments of the present disclosure, a method of including information of specified characteristics in a URL include using a predefined symbol to include or otherwise join the information of the specified characteristics in the URL. For example, the “&” symbol is used to include the desired information within the URL. The predefined symbol serves as a demarcation point between types of information (e.g., an address and a specified characteristic).

For example, assuming that the URL corresponding to the web page is http://item.example.com/item.htm?id=1234567. Thus, if a specified characteristic is included in the URL, and the specified characteristic is assumed to be product name, then after including the product name to the URL, the URL for the web page is: http://item.example.com/item.htm?id=1234567&item_name=product name. According to such an example, the “item_name” included after the predefined symbol “&” corresponds to the product name (e.g., the “product name” corresponds to the value of the specified characteristic included in the URL). Similarly, other specified characteristic information can be included in the URL. Accordingly, when a receiver terminal (e.g., a receiver client) receives a URL in which specified characteristic information has been included (e.g., a URL to which specified characteristic information is joined), the receiver terminal can extract the information included in the URL (e.g., the specified characteristic information) directly from the URL. As an example, the receiver terminal can extract the information included in the URL directly from the URL if the appropriate template has been saved and add the extracted information to the template for rendering and presentation. In the above example, after the receiver terminal receives the URL “http://item.example.com/item.htm?id=1234567&item_name=product name”, the receiver terminal can determine the “item_name” field therein through analysis, extract the value “product name” from the field, and add the extracted value to the template. In some embodiments, the receiver terminal acquires information of other specified characteristics not carried in the URL (e.g., name of vendor at which the product is located, picture of shop, amount of product in stock, location of the product, and/or the like). For example, the receiver terminal establishes a connection with the server through (e.g., using) the received URL and acquire information of other specified characteristics from the server. Thereafter, the receiver terminal adds the acquired information (e.g., the information of the other specified characteristic) to the template.

According to various embodiments of the present disclosure, because images cannot be directly included in the URL, if image information is included within the specific characteristic information (such as the vendor image mentioned above), then the URL of the image is included or otherwise joined to the URL corresponding to the web page. For example, image information is included with the specific characteristic information, then the sending terminal (e.g., the sending client) includes a URL associated with the image information with the URL corresponding to the web page. Accordingly, if a URL corresponding to an image has been included with (e.g., joined to) the URL received by the receive terminal (e.g., the receiver client), then the receiver terminal (e.g., the receiver client) can use the URL corresponding to the image that has been included with or otherwise joined to the URL received by the receiver terminal as a basis for acquiring the appropriate image from a server. The receiver terminal can add the acquired image to the corresponding template.

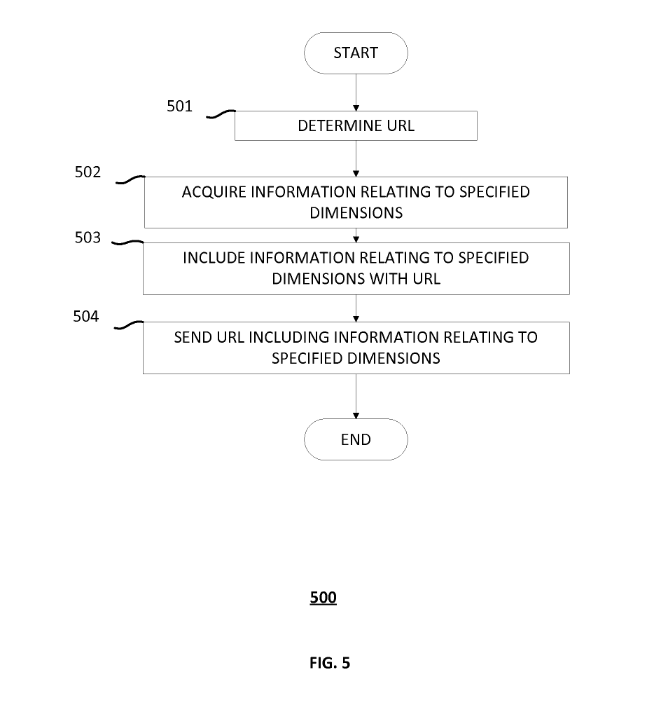

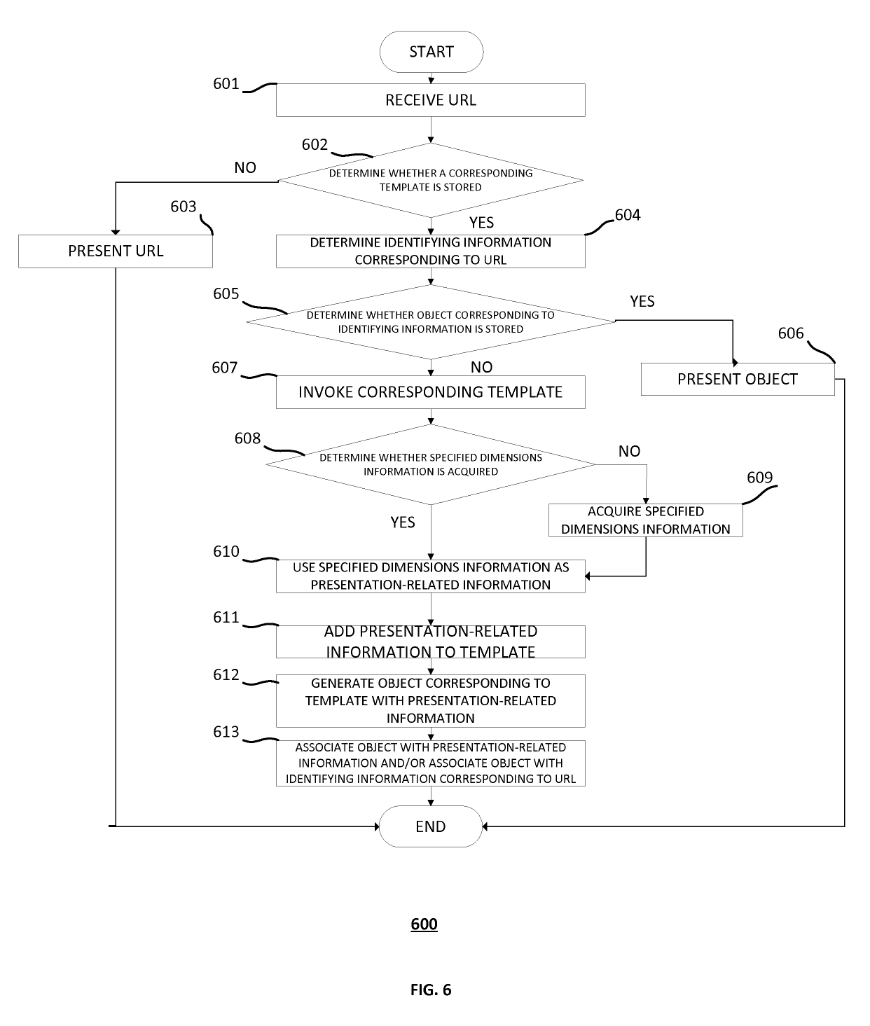

FIG. 5 is a flowchart of a method for presenting information according to various embodiments of the present disclosure.

Referring to FIG. 5, a method 500 for presenting information is provided. In some embodiments, the method 500 is implemented is implemented by a device such as terminal 710 illustrated in FIG. 7.

At 501, a URL corresponding to presentation-related information is determined. In some embodiments, a sender terminal (e.g., the sender client) determines a URL corresponding to presentation-related information. The sender terminal generates the URL based on one or more of the presentation-related information and the web page.

At 502, information relating to one or more specified characteristics is acquired. In some embodiments, the sender terminal acquires information relating to one or more specified characteristics. The sender terminal acquires the information relating to one or more specified characteristics in the presentation-related information.

At 503, the acquired information relating to the one or more specified characteristics is included in the URL. In some embodiments, the sender terminal includes the acquired information relating to one or more specified characteristics in the URL. The sender terminal joins the acquired information relating to one or more specified characteristics in the URL.

At 504, the acquired information relating to one or more specified characteristics and the URL are communicated. In some embodiments, the sender terminal sends the acquired information relating to one or more specified characteristics and the URL to one or more receiver terminal (e.g., receiver clients). For example, the sender terminal sends the URL including or otherwise joined with the one or more specified characteristics to a receiver terminal.

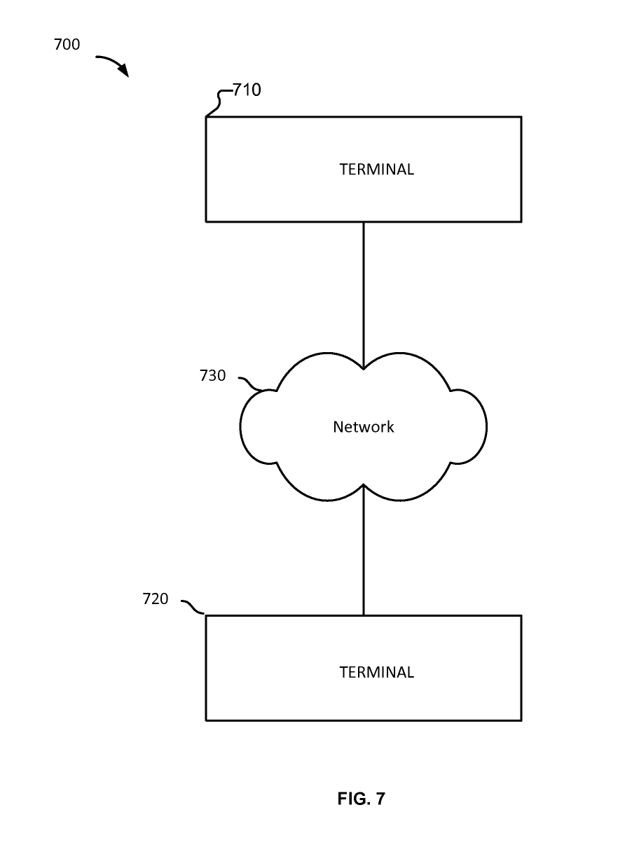

FIG. 6 is a flowchart of a method for presenting information according to various embodiments of the present disclosure.

Referring to FIG. 6, a method 600 for presenting information is provided. In some embodiments, the method 600 is implemented by a device such as terminal 720 illustrated in FIG. 7.

At 601, a URL is received. In some embodiments, a receiver terminal (e.g., a receiver client) receives a URL sent by a sender terminal (e.g., a sender client).

At 602, a determination is made as to whether a corresponding template is stored. In some embodiments, the receiver terminal (e.g., the receiver client) determines whether a corresponding template is stored. For example, the receiver terminal determines whether the receiver terminal stores a template corresponding to presentation-related information that is associated with the received URL. For example, the URL includes category information corresponding to the presentation-related information. In some embodiments, the receiver terminal extracts or otherwise acquires category information corresponding to the presentation-related information from the received URL. In some embodiments, the receiver terminal determines whether the receiver terminal stores a template corresponding to the category information.

If a template is not stored at 602, then the URL is presented. In some embodiments, the receiver terminal determines that a corresponding template is not stored at 602, then, at 603, the receiver terminal presents the URL (e.g., to the user).

In contrast, if a corresponding template is stored at 602, then, at 604, identifying information corresponding to the URL is determined. In some embodiments, if the receiver terminal determines that a corresponding template is stored at 602, then, at 604, the receiver terminal determines identifying information corresponding to the URL. For example, the receiver terminal uses a preset process to determine identifying information corresponding to the URL. As another example, the URL includes the identifying information.

At 605, a determination is made as to whether an object corresponding to the identifying information is stored. In some embodiments, the receiver terminal determines whether an object corresponding to the identifying information is stored. For example, the receive terminal determines whether the receiver terminal stores an object corresponding to the identifying information associated with or otherwise relating to the URL. In some embodiments, the object is an image, the like, or a combination thereof.

If an object corresponding to the identifying information is stored at 605, then, at 606, the object corresponding to the identifying information is stored. In some embodiments, if the receiver terminal determines that an object corresponding to the identifying information is store at 605, then, at 606, the receiver terminal presents the object corresponding to the identifying information.

In contrast, if an object corresponding to the identifying information is not stored at 605, then, at 607, a corresponding template is invoked. In some embodiments, if the receiver terminal determines that an object corresponding to identifying information is not stored at 605, then, at 607, the receiver terminal invokes a corresponding template. In some embodiments, the receiver terminal invokes the template corresponding to the category information of the presentation-related information.

At 608, a determination is made as to whether specified characteristics information is acquired. In some embodiments, the receiver terminal determines whether specified characteristics information is acquired.

If specified characteristics information is not acquired at 608, then, at 609, specified characteristics information is acquired. In some embodiments, if the receiver terminal determines that specified characteristics information is not acquired at 608, then, at 609, the receiver terminal acquires specified characteristics information. For example, the receiver terminal uses preset characteristics as a basis for acquiring specified characteristics information that is included with or otherwise joined with the URL. As another example, the receiver terminal may acquire information corresponding to the URL from the server and extract the specified characteristics information from the acquired information. In some embodiments, the receiver terminal acquires the information corresponding to the URL from the server and extract the specified characteristics information if the specified characteristics information is not included or otherwise joined with the URL. Thereafter, the method for presenting information proceeds to 610.

In contrast, if specified characteristics are acquired at 608, then the method for presenting information proceeds to 610. In some embodiments, if the receiver terminal determines that specified characteristics information is acquired at 608, then the method for presenting information proceeds to 610.

At 610, the specified characteristics are used as presentation-related information. In some embodiments, the receiver terminal uses the specified characteristics as presentation-related information. For example, the receiver terminal sets the specified characteristics to correspond to the presentation-related information.

At 611, the presentation-related information is added to the template. In some embodiments, the receiver terminal adds the presentation-related information to the template. For example, the receiver terminal adds the presentation-related information to the invoked template corresponding to the category information (e.g., the category information of the presentation-related information that is included in the URL).

At 612, an object corresponding to the template is generated from the presentation-related information. In some embodiments, the receiver terminal generates an object corresponding to the template with the presentation-related information. For example, in the template an image that presents the presentation-related information is generated. The object (e.g., the image) may be stored.

At 613, the object is associated with presentation-related information and/or the object is associated with identifying information corresponding to the URL. For example, the receiver terminal establishes a correspondence between the identifying information corresponding to the URL and the generated image.

FIG. 7 is a diagram illustrating a system for presenting information according to various embodiments of the present disclosure.

Referring to FIG. 7, the system 700 for presenting information includes a terminal 710 (e.g., a sender terminal), a terminal 720 (e.g., a receiver terminal), and a network 730. As illustrated in FIG. 7, the terminal 710 communicates with the terminal 720 across the network 730.

According to various embodiments of the present disclosure, the terminal 710 receives a request for presentation-related information. For example, the terminal 710 receives a request for presentation-related information from the terminal 720. In some embodiments, the terminal 710 sends identifying information associated with presentation-related information to the terminal 720. In some embodiments, the sender terminal (e.g., the terminal 710) sends the identifying information associated with the presentation-related information concurrently with presentation-related information. For example, the identifying information corresponds to or otherwise includes metadata included with the presentation-related information. In some embodiments, the sender terminal (e.g., terminal 710) sends the identifying information associated with the presentation-related information to a receiver device (e.g., a receiver terminal, a server, and/or the like). In some embodiments, the presentation-related information corresponds to or otherwise includes product information.

According to various embodiments of the present disclosure, the terminal 710 determines a URL corresponding to the presentation-related information. In some embodiments, the terminal 710 acquires information relating to one or more specified characteristics and include the information relating to one or more specified characteristics with the URL. In some embodiments, the terminal 710 sends the URL including or otherwise joined with the one or more specified characteristics to the terminal 720.

According to various embodiments of the present disclosure, the terminal 720 receives identifying information associated with presentation-related information. In some embodiments, the terminal 720 determines whether the terminal 720 stores an object corresponding to received identifying information. If the terminal 720 stores an object corresponding to the received identifying information, then the terminal 720 retrieves the object and present (e.g., display) the object. In contrast, if the terminal 720 does not store an object corresponding to the received identifying information, then the terminal renders the object, save the object, and present the object.

According to various embodiments of the present disclosure, the terminal 720 receives a URL from the terminal 710. The terminal 720 determines whether the terminal 720 has a template corresponding to the URL (e.g., a template corresponding to category information included in the URL). If the terminal 720 does not have such a template, then the terminal 720 presents the URL. In contrast, if the terminal 720 has such a template, then the terminal determines identifying information corresponding to the URL. In some embodiments, the terminal 720 determines whether the terminal stores an object corresponding to the identifying information. In some embodiments, if the terminal 720 has such an object, then the terminal 720 presents the object. In contrast, if the terminal 720 does not have such an object, then the terminal invokes a corresponding template, acquire specified characteristics that serve as the presentation-related information, add the presentation-related information to the invoked template, and generate an object corresponding to the template with presentation-related information. In some embodiments, the terminal 720 associates the generated object with the presentation-related information included in the populated template and/or associate the object with identifying information corresponding to the URL.

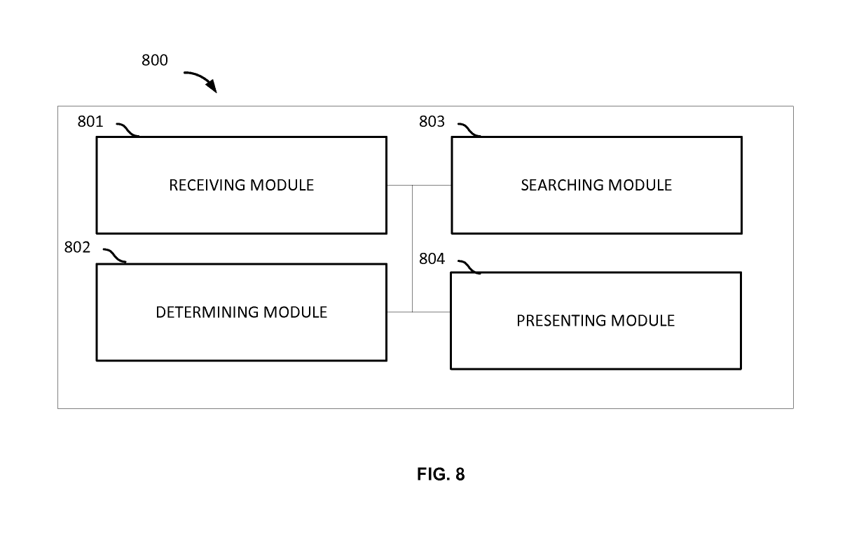

FIG. 8 is a structural block diagram of an information presentation device provided by an embodiment of the present application.

Referring to FIG. 8, an information presentation device 800 for presenting information is provided. In some embodiments the information presentation device 800 implements method 100 illustrated in FIG. 1. In some embodiments the information presentation device 800 implements method 600 illustrated in FIG. 6.

The information presentation device 800 includes a receiving module 801, a determining module 802, a searching module 803, a presenting module 804, and/or the like.

In some embodiments, the receiving module 801 receives presentation-related information that is sent by a sender terminal (e.g., a sender client). In some embodiments, the receiving module 501 receives a URL from the sender terminal.

In some embodiments, the determining module 802 determines identifying information corresponding to the presentation-related information.

In some embodiments, the searching module 803 searches for an object corresponding to the identifying information. For example, the searching module 803 searches for an image corresponding to the identifying information among images saved by the information presentation device 800 (e.g., the receiver client).

In some embodiments, the presenting module 804 presents an object corresponding to the identifying information. For example, the presenting module 804 presents a found image when the searching module 803 successfully finds an image corresponding to the identifying information. If the searching module 803 fails to find an object (e.g., an image) corresponding to the identifying information, then the presenting module 803 invokes the rendering template used to present presentation-related information. In some embodiments, the presenting module 804 adds the presentation-related information to the rendering template. The presenting module 804 renders and present the template (e.g., including the presentation-related information). The presenting module 804 generates a presentation result of the presentation-related information as an object (e.g., an image) and save the object. The presenting module 804 establishes a correspondence between the identifying information and the generated object (e.g., the generated image).

In some embodiments, the receiving module 801 is further configured to receive URL corresponding to presentation-related information that is sent by the sender terminal (e.g., the sender client).

In some embodiments, the determining module 802 is further configured to use a preset process to determine the identifying information corresponding to the URL. In some embodiments, the identifying information corresponds to the identifying information corresponding to the determined presentation-related information.

In some embodiments, the presenting module 804 is further configured to acquire the presentation-related information according to the URL. In some embodiments, the presenting module 804 adds the presentation-related information to the rendering template and render and present the template (e.g., the template populated with the presentation-related information).

In some embodiments, the presenting module 804 is further configured to present the received URL when the rendering template fails to be invoked.

In some embodiments, the presenting module 804 is further configured to use the category information of the presentation-related information that is carried in the received URL as a basis for invoking the rendering template corresponding to the category information.

In some embodiments, the presenting module 804 is further configured to use preset specified characteristics as a basis for acquiring information for the specified characteristics included or otherwise joined in the URL to serve as the acquired presentation-related information. If specified characteristic information is not acquired from the URL, then the presenting module 804 acquires information corresponding to the URL from a server and extract from the acquired information the specified characteristic information to serve as the acquired presentation-related information.

The aforesaid information presentation device as shown in FIG. 5 can be specifically located on a receiver terminal (e.g., a receiver client).

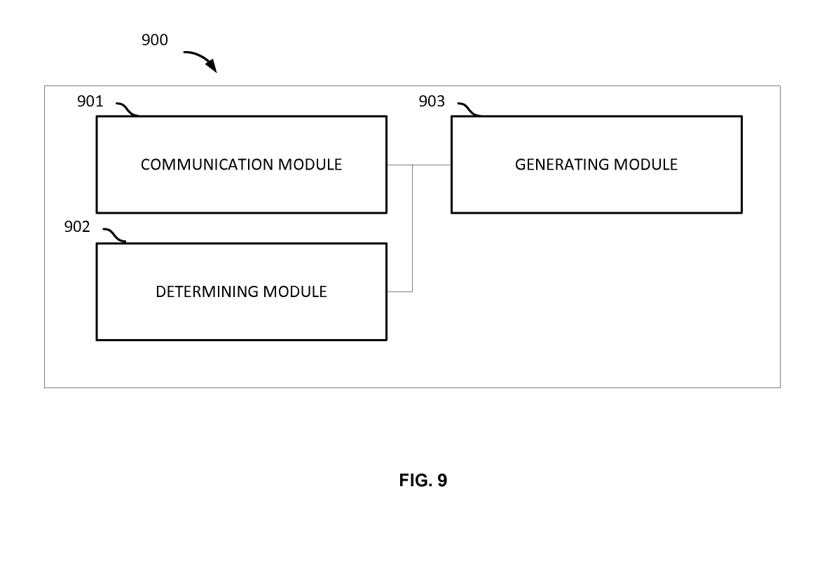

FIG. 9 is a structural block diagram of a sender device provided by an embodiment of the present application.

Referring to FIG. 9, a sender device 900 (e.g., the sender terminal) for presenting information is provided. In some embodiments the sender device implements method 200 illustrated in FIG. 2. In some embodiments the sender device 900 implements method 500 illustrated in FIG. 5. In some embodiments the sender device 900 implements method 600 illustrated in FIG. 6.

The sender device 900 includes a communication module 901, a determining module 902, a generating module 903, and/or the like.

In some embodiments, the communication module 901 communicates with a receiver terminal (e.g., a receiver client). In some embodiments, the communication module 901 receives a request for presentation-related information. In some embodiments, the communication module 901 sends identifying information associated with presentation-related information to a receiver terminal.

In some embodiments, the determining module 902 determines a URL. For example, the determining module 902 determines a URL corresponding to presentation-related information. In some embodiments, the determining module 902 acquires information relating to specified characteristic.

In some embodiments, the generating module 903 generates a URL. In some embodiments, the generating module includes information relating to specified characteristics in the URL.

In some embodiments, the communication module 901 is further configured to send a URL including information relating to specified characteristics to a receiver terminal.

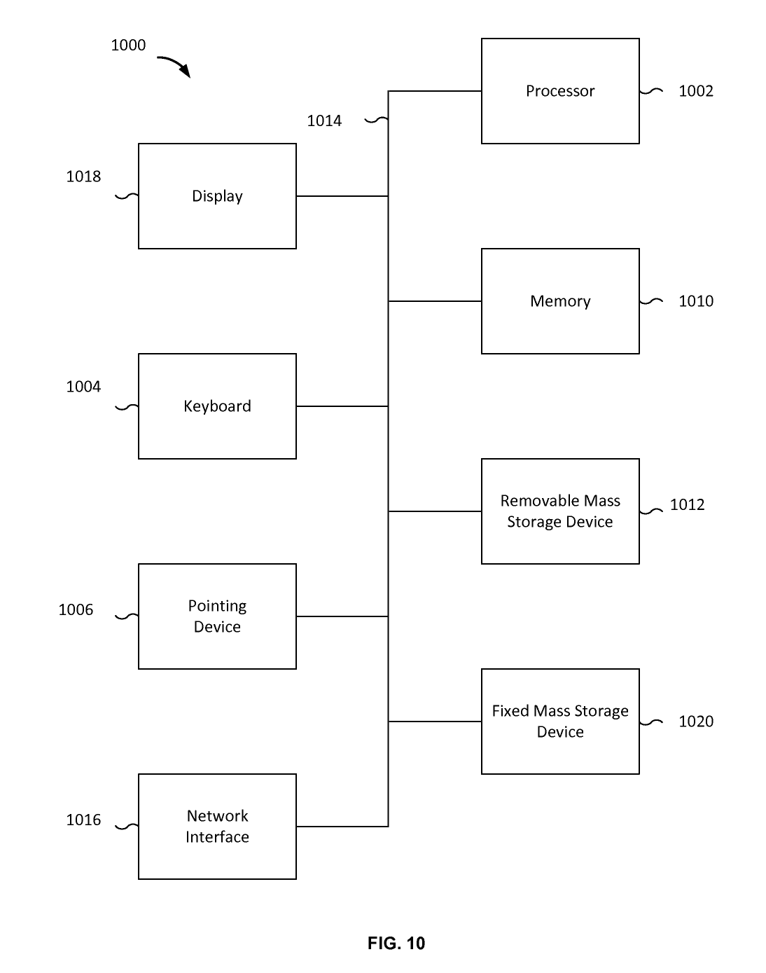

FIG. 10 is a functional diagram of a computer system for presenting information, according to various embodiments of the present disclosure.

Referring to FIG. 10, a computer system 1000 for accessing a website or for determining whether a terminal accessing the website is a mobile terminal is provided. As will be apparent, other computer system architectures and configurations can be used to implementing video calls. Computer system 1000, which includes various subsystems as described below, includes at least one microprocessor subsystem (also referred to as a processor or a central processing unit (CPU)) 1002. For example, processor 1002 can be implemented by a single-chip processor or by multiple processors. In some embodiments, processor 1002 is a general purpose digital processor that controls the operation of the computer system 1000. Using instructions retrieved from memory 1010, the processor 1002 controls the reception and manipulation of input data, and the output and display of data on output devices (e.g., display 1018).

Processor 1002 is coupled bi-directionally with memory 1010, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 1002. Also as is well known in the art, primary storage typically includes basic operating instructions, program code, data and objects used by the processor 1002 to perform its functions (e.g., programmed instructions). For example, memory 1010 can include any suitable computer-readable storage media, described below, depending on whether, for example, data access needs to be bi-directional or uni-directional. For example, processor 1002 can also directly and very rapidly retrieve and store frequently needed data in a cache memory (not shown).

A removable mass storage device 1012 provides additional data storage capacity for the computer system 1000, and is coupled either bi-directionally (read/write) or uni-directionally (read only) to processor 1002. For example, storage 1012 can also include computer-readable media such as magnetic tape, flash memory, PC-CARDS, portable mass storage devices, holographic storage devices, and other storage devices. A fixed mass storage 1020 can also, for example, provide additional data storage capacity. The most common example of mass storage 1020 is a hard disk drive. Mass storage device 1012 and fixed mass storage 1020 generally store additional programming instructions, data, and the like that typically are not in active use by the processor 1002. It will be appreciated that the information retained within mass storage device 1012 and fixed mass storage 1020 can be incorporated, if needed, in standard fashion as part of memory 1010 (e.g., RAM) as virtual memory.

In addition to providing processor 1002 access to storage subsystems, bus 1014 can also be used to provide access to other subsystems and devices. As shown, these can include a display monitor 1018, a network interface 1016, a keyboard 1004, and a pointing device 1006, as well as an auxiliary input/output device interface, a sound card, speakers, and other subsystems as needed. For example, the pointing device 1006 can be a mouse, stylus, track ball, or tablet, and is useful for interacting with a graphical user interface.

The network interface 1016 allows processor 1002 to be coupled to another computer, computer network, or telecommunications network using a network connection as shown. For example, through the network interface 1016, the processor 1002 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 1002 can be used to connect the computer system 800 to an external network and transfer data according to standard protocols. For example, various process embodiments disclosed herein can be executed on processor 1002, or can be performed across a network such as the Internet, intranet networks, or local area networks, in conjunction with a remote processor that shares a portion of the processing. Additional mass storage devices (not shown) can also be connected to processor 1002 through network interface 1016016.

An auxiliary I/O device interface (not shown) can be used in conjunction with computer system 1000. The auxiliary I/O device interface can include general and customized interfaces that allow the processor 1002 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 10 is but an example of a computer system suitable for use with the various embodiments disclosed herein. Other computer systems suitable for such use can include additional or fewer subsystems. In addition, bus 1014 is illustrative of any interconnection scheme serving to link the subsystems. Other computer architectures having different configurations of subsystems can also be utilized.

The modules described above can be implemented as software components executing on one or more general purpose processors, as hardware such as programmable logic devices and/or Application Specific Integrated Circuits designed to perform certain functions or a combination thereof. In some embodiments, the modules can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules may be implemented on a single device or distributed across multiple devices. The functions of the modules may be merged into one another or further split into multiple sub-modules.

The methods or process steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

Various embodiments of the present disclosure provide a method and a device for presenting information. According to the method, after a receiver client receives presentation-related information, the receiver client determines the identifying information corresponding to the presentation-related information and looks up an image corresponding to the identifying information. If the looking up is successful, then the receiver client presents the looked up image. If the look up is not successful, then the receiver client invokes a rendering template and adds the presentation-related information to the rendering template and renders and presents the populated template. The receiver client generates the presentation result of the presentation-related information as an image and saves the image and establishes a correspondence between the identifying information and the generated image. However, with the method described above, the receiver client can save an image that presents the presentation-related information whenever at least a portion of presentation-related information is rendered and presented. Moreover, the next time that the same presentation-related information is received, the receiver client directly presents a saved image to the user without having to render the presentation-related information again. Accordingly, various embodiments of the present disclosure can effectively conserve the computing resources and power that are used in rendering presentation-related information.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method comprising:
determining, by a receiver terminal, identifying information corresponding to presentation-related information;
searching for an image corresponding to the identifying information among one or more images stored on the receiver terminal;
in response to the receiver terminal finding the image corresponding to the identifying information, presenting the image corresponding to the identifying information;
in response to determining that the receiver is not able to locate the image corresponding to the identifying information among the one or more images stored on the receiver terminal, invoking a rendering template to populate the presentation-related information into the rendering template, and rendering the populated template to generate rendered information;
generating, based on the rendered information, a presentation result comprising a generated image; and
establishing a correspondence between the identifying information and the generated image.

2. The method as described in claim 1, wherein the generating of the presentation result comprises:
presenting the rendered information;
generating the presentation result of the presentation-related information as an image; and
saving the generated picture.

3. The method as described in claim 2, wherein the receiving of presentation-related information further comprises:
receiving, by the receiver terminal, a Uniform Resource Locator (URL) corresponding to the presentation-related information that is sent by the sender terminal,
wherein the determining of the identifying information corresponding to the information further comprises:
determining, using a preset process, the identifying information corresponding to the URL, wherein the identifying information corresponding to the URL corresponds to the identifying information corresponding to the presentation-related information, and
wherein the populating of the rendering template with presentation-related information and the rendering and presenting of the populated template further comprises:
acquiring the presentation-related information according to the URL; and
populating the rendering template with the acquired presentation-related information and presenting the template populated with the acquired presentation-related information.

4. The method as described in claim 3, further comprising:
in response to the receiver terminal failing to invoke the rendering template, presenting the received URL.

5. The method as described in claim 3, wherein the invoking of the rendering template for presenting presentation-related information further comprises:
using category information of the information presenting carried in the received URL as a basis for invoking the rendering template corresponding to the category information.

6. The method as described in claim 3, wherein the acquiring of the presentation-related information according to the URL further comprises:
using preset specified characteristics as a basis for acquiring information for the specified characteristics included in the URL to serve as the acquired presentation-related information;
if the URL does not include the specified characteristics information, then acquiring information corresponding to the URL from the server and extracting from the acquired information the specified characteristics information to serve as the acquired presentation-related information.

7. The method as described in claim 1, wherein the presentation-related information is assembled in JSON data format.

8. A device comprising:
a determining module configured to determine identifying information corresponding to presentation-related information;
a searching module configured to search for an image corresponding to the identifying information among one or more images stored on the device;
a presenting module configured to present the image corresponding to the identifying information when the searching module finds an image corresponding to the identifying information and, to invoke a rendering template for presenting presentation-related information, to populate the presentation-related information into the rendering template, and to the populated template, to generate, based on the rendered information, a presentation result comprising a generated image, and to establish a correspondence between the identifying information and the generated image when the searching module is determined to not be able to find an image corresponding to the identifying information among the one or more images stored on the device.

9. The device as described in claim 8, wherein the presenting module generates the presentation result by presenting the rendered information, generating the presentation result of the presentation-related information as an image, and saving the generated image.

10. The device as described in claim 9, wherein the receiving module is further configured to receive a Uniform Resource Locator (URL) corresponding to presentation-related information that is sent by the sender terminal,
wherein determining module is further configured to determine, using a preset process, the identifying information corresponding to the URL, wherein the identifying information corresponding to the URL corresponds to the identifying information corresponding to the presentation-related information, and
wherein the presenting module further configured to acquire the presentation-related information according to said URL, and to populate the rendered template with the acquired presentation-related information, to render and present the template populated with the acquired presentation-related information.

11. The device as described in claim 10, wherein the presenting module is further configured to present the received URL in response to the device failing to invoke the rendering template.

12. The device as described in claim 10, wherein the presenting module is further configured to use the category information of the presentation-related information carried in the received URL as a basis for invoking the rendering template corresponding to the category information.

13. The device as described in claim 10, wherein the presenting module is further configured to use preset specified characteristics as a basis for acquiring information for the specified characteristics included in the URL to serve as the acquired presentation-related information, and to acquire information corresponding to the URL from the server and extracting from the acquired information the specified characteristics information to serve as the acquired presentation-related information, if said specified characteristics information is not acquired from said URL.

14. The device described in claim 8, wherein the presentation-related information is assembled in JSON data format.

15. A sender device comprising:
a communication module configured to receive a request for presentation-related information, and to send a Uniform Resource Locator (URL) including information relating to specified characteristics to a receiver terminal;
a determining module configured to determine a URL corresponding to presentation-related information; and
a generating module configured to generate the URL including information relating to specified characteristics using the URL corresponding to the presentation-related information.

16. A computer program product for presenting information, the computer program product being embodied in a tangible non-transitory computer-readable storage medium and comprising computer instructions for:
determining, by a receiver terminal, identifying information corresponding to presentation-related information; and
searching for an image corresponding to the identifying information among one or more images stored on the receiver terminal;
in response to the receiver terminal finding the image corresponding to the identifying information, presenting the image corresponding to the identifying information;
in response to determining that the receiver is not able to locate the image corresponding to the identifying information among the one or more images stored on the receiver terminal, invoking a rendering template for presenting presentation-related information and populating the presentation-related information into the rendering template, and rendering the populated template;
generating, based on the rendered information, a presentation result comprising a generated image; and
establishing a correspondence between the identifying information and the generated image.
